(19) United States
(12) Patent Application Publication
(10) Pub. No.: US 2007/0257383 A1
(43) Pub. Date: Nov. 8, 2007

(54) Wearable Self-Contained Personal Humidifier

(76) Inventor: Kelvin Chan, Kowloon (HK)

Correspondence Address: SMITH HOPEN, PA, 180 PINE AVENUE NORTH, OLDSMAR, FL, 34677, US

(21) Appl. No.: 11/672,097

(22) Filed: Feb. 7, 2007

Related U.S. Application Data
(60) Provisional application No. 60/797,668, filed on May 5, 2006.

(51) Int. Cl. B01F 3/04

(52) U.S. Cl. 261/107; 261/DIG. 88

(57) ABSTRACT

A personal humidifier includes a main body having a centrally apertured front wall and an open back. A rear cover closes the open back and a sponge-retaining cavity is formed by the main body and the rear cover. Ambient air enters into the cavity through air inlets formed in the rear cover and flows through a water-retaining sponge. A fan is mounted on an output shaft of a DC motor and pulls humidified and cooled air out of the cavity after the air has passed through the water-retaining sponge. Guide vanes direct the humidified and cooled air towards a user's face when the personal humidifier is attached to a neck strap and positioned in overlying relation to the user's chest.

### CROSS REFERENCE TO RELATED APPLICATION

Pursuant to 35 U.S.C. § 119(e), this application claims priority to U.S. provisional application No. 60/797,668 filed May 5, 2006 by the same inventor, the contents of which are hereby incorporated by reference.

### BACKGROUND OF THE INVENTION

1. Field of the Invention

This invention relates to a wearable self-contained device for improving the wearer's breathing air and providing humidified air for the wearer's facial skin, mouth and eyes. More particularly, it relates to a wearable device that functions as a personal humidifier or a personal air cooler, or both, for use in hot, dry, or hot and dry environments.

2. Description of the Prior Art

Conventional evaporative stand-alone household humidifiers increase the relative humidity of the air in the room in which they are positioned. Such humidifiers are typically large and bulky in design and are placed atop a furniture surface or upon a floor surface. They are often characterized as being “portable,” but they require external power. They include a water reservoir from which water is spilled if the unit is tipped over or moved abruptly.

Accordingly, such humidifiers cannot be carried on the body of a user.

However, there is a need for a truly portable humidifier that can be carried by a user so that it goes wherever the user goes. For example, in dry aircraft cabins, and in automobiles, it is not feasible to employ conventional household humidifiers due to their size, weight, power requirements, and concomitant lack of portability.

The relative humidity in an aircraft cabin may drop to about five per cent (5%) during a long haul flight due to extremely dry intake air from high altitudes. Passengers therefore suffer from health problems or personal discomforts such as nasal irritation, nose bleed, dry throat, chapped lips, dry itchy skin, sinus pain, and fatigue. Any moisture, if present, from intake air is removed due to icing concerns. Although some aircraft may be fitted with humidifiers, most are not used to full capacity.

Relative humidity may be as low as ten per cent (10%) in a heated home. Central humidifying systems are available, but they are costly and require periodic maintenance. Stand-alone room humidifiers are impractical in homes with large numbers of rooms, especially when only a few of the rooms are actually used most of the time.

Thus there is a need for a self-powered, portable personal humidifier.

U.S. Pat. No. 5,749,359 discloses a portable air conditioning or air purifying unit for persons with health problems. The device may include a detachable humidifying unit but there is no disclosure as to how the humidifying unit is fabricated. The device is too complicated and too cumbersome for passengers to carry onboard an aircraft.

U.S. Pat. No. 5,802,865 discloses a personal cooling device in the form of a C-shaped band that fits conformably around a portion of a user's body. The device has a water-retaining material and a DC powered fan that draws air and facilitates evaporation of water from the water-retraining material. The evaporation cools a heat dissipating metal surface which is biased to press against the body portion thereby exerting cooling effects. This device cools body parts, particularly the forehead and the neck, by direct contact with the body part. It does not direct moisturized air toward a person's nose, mouth or face to solve the above-mentioned health problems commonly encountered by air travel passengers.

There is a need for a discreet, light-weight, portable, self-powered, personal humidifier or air cooler, or both, that is adapted to be carried by the user and provide humidified air to an individual on a personal scale.

However, in view of the prior art considered as a whole at the time the present invention was made, it was not obvious to those of ordinary skill in this art how the identified needs could be met.

### SUMMARY OF THE INVENTION

The long-standing but heretofore unfulfilled need for a personal humidifier is now met by a new, useful, and nonobvious invention.

The novel personal humidifier includes a main body having a front wall. An opening is formed in the front wall, substantially centrally thereof. A top wall, a bottom wall, and a pair of sidewalls extend rearwardly from peripheral edges of the front wall.

A rear cover has peripheral edges that releasably engage respective trailing edges of the top wall, bottom wall, and pair of sidewalls. A cavity adapted to accommodate a sponge means therewithin is formed when the rear cover is engaged to the main body. The sponge means is adapted to hold water or other suitable liquid fluid therewithin so that air passing through the sponge means is cooled and humidified.

The rear cover has a top wall, an imperforate back wall, a pair of sidewalls, and a bottom wall. A plurality of air inlets is formed in the top wall of the rear cover and a plurality of linear struts are formed integrally with the rear cover back wall on a forwardly-facing side thereof. An elongate air duct is formed between each contiguous pair of linear struts.

A fan is mounted on the output shaft of a DC motor for conjoint rotation therewith. The DC motor and the fan are mounted on a forward side of the main body front wall, substantially centrally thereof, so that motor-driven rotation of the fan constrains ambient air to follow a path of travel through the air inlets, the elongate air ducts, the sponge means, and the opening formed in the front wall.

An air outlet is positioned forwardly of the front wall and constrains cooled and humidified air to flow through the air outlet so that the air flow of cooled and humidified air may be breathed by a user. This improved, moist air is delivered to the facial area of the user as well, promoting better skin conditions and alleviating the condition of dry eyes.

An important advantage of the invention is that a user may breathe the cooled and humidified air even when the ambient air is low in humidity.

Another important advantage is that the humidified air released provides relief for dry facial skin, lips and eyes.

Another important advantage is that the inventive humidifier is small and light-in-weight, and capable of being powered by an independent power source disposed within the device itself so that a user can take it anywhere.

Another important advantage is that the invention instantaneously produces cool air which is a by-product of evaporated humidified air, therefore making the novel device an effective personal air cooler that can be useful in hot and dry environments.

Still another advantage is that the novel device may be used as an aromatherapy device, providing aromatic air to the user. The therapeutic effects are efficiently delivered because the device is placed in proximity to the nose of the user.

Yet another advantage is that the device may provide effective relief for users suffering from common colds or flu where humidified air is beneficial and comfortable. The uses extend to users suffering from asthma and similar problems breathing extremely dry air. The therapeutic effects may be enhanced by adding menthol oils or similar essences onto the sponge.

These and other advantages will become apparent as this disclosure proceeds and the scope of the invention will be indicated in the claims.

### BRIEF DESCRIPTION OF DRAWINGS

For a fuller understanding of the nature and objects of the invention, reference should be made to the accompanying description and to the drawings in which:

FIG. 1 is a side view of the novel device being worn by a user;

FIG. 2 is an exploded view of all the components that form the device depicted in FIG. 1;

FIG. 3 is a front elevational view including a cross-section of the fan structure of the preferred embodiment;

FIG. 4 is a transverse sectional view of the preferred embodiment;

FIG. 5 is a rear view of the main body with the rear cover and sponge removed; and

FIG. 6 is a longitudinal sectional view of the preferred embodiment.

### DETAILED DESCRIPTION OF THE PREFERRED EMBODIMENT

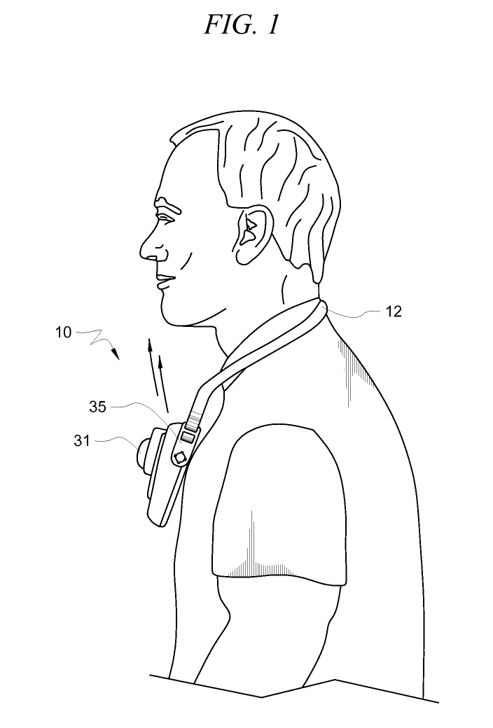

Referring now to FIG. 1, it will there be seen that an illustrative embodiment of the invention is denoted as a whole by the reference numeral 10. In this particular embodiment, personal humidifier 10 is connected to elongate neck strap 12 so that it lies atop the chest of a user, substantially centrally thereof, with the humidified and cooled air following a path of travel towards a users' face as indicated by the directional arrows.

The length of elongate neck strap may be adjusted in several well-known ways. For example, the neck strap construction may incorporate slide-buckles, hook and loop fasteners, and the like. This enables the user to easily adjust the distance between the device and the facial area of the user.

In lieu of neck strap 12, a clip, not depicted, may be secured to humidifier 10 so that it can be clipped to a user's clothing. Alternatively, humidifier 10 may be hand-held.

A suction cup, not depicted, may also be provided so that humidifier 10 may be temporarily attached to an aircraft folding seat-back tray or LCD display panel.

A suitable mounting mechanism permitting the humidifier to be mounted on a forward tray or a ledge of a passenger seat could also be incorporated into the structure of the humidifier.

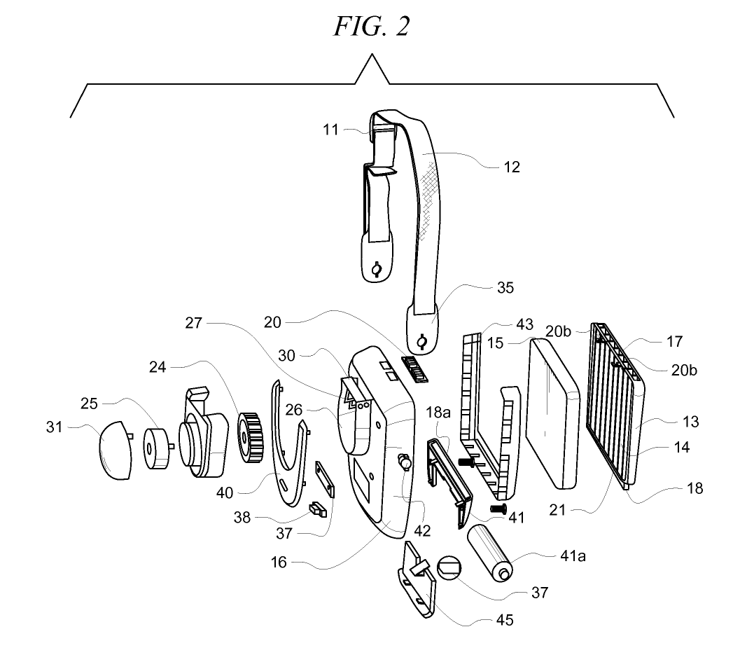

In the embodiment depicted in FIG. 2, rear slide buckle 11 has a conventional structure as depicted and enables the user to adjust the length of neck strap 12. A non-adjustable strap is also within the scope of this invention.

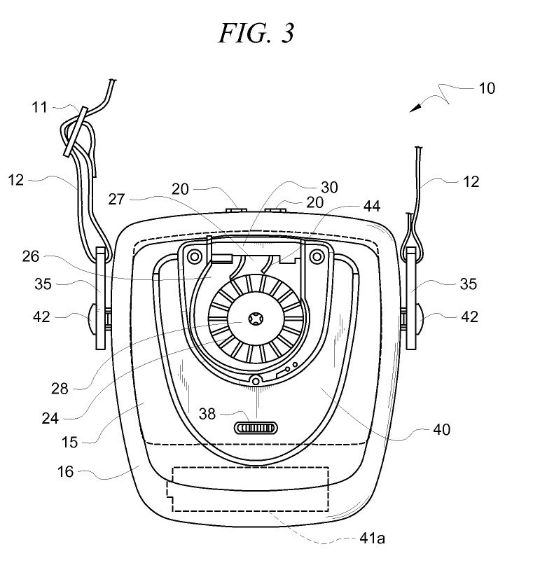

The opposite ends of neck strap 12 are formed into loops that engage attachment members 35, as best depicted in FIG. 3. Each attachment member 35 is centrally apertured as indicated in FIG. 2. Each aperture includes a central round opening and a pair of diametrically opposed slots that are radially disposed with respect to the round opening.

The main body of personal humidifier 10 is denoted 16 in FIG. 2. Main body 16 includes a front wall, a pair of opposing sidewalls, a top wall and a bottom wall, all integrally formed with one another and collectively forming a cavity that is sized to accommodate sponge 15. Main body 16 has no back wall. The function of a back wall is performed by rear cover 13.

Neck strap connector post 42 is formed integrally with each of the sidewalls of main body 16 as may be discerned from FIG. 2 and as fully depicted in FIG. 3. Posts 42 act as a guide to facilitate alignment of main body 16 and removable rear cover 13. Each post is surmounted by a head that is complementally formed to mate with the openings formed in attachment members 35, i.e., each post head is round in configuration with a pair of diametrically opposed, radially outwardly extending tabs. The opening formed in each attachment member 35 is aligned with the head so that the tabs align with the slots formed in the opening. Each attachment member 35 is then pressed over its associated head and each attachment member is rotated so that the slots and tabs misalign, thereby securely connecting each attachment member to its associated post, as best understood in connection with FIG. 3.

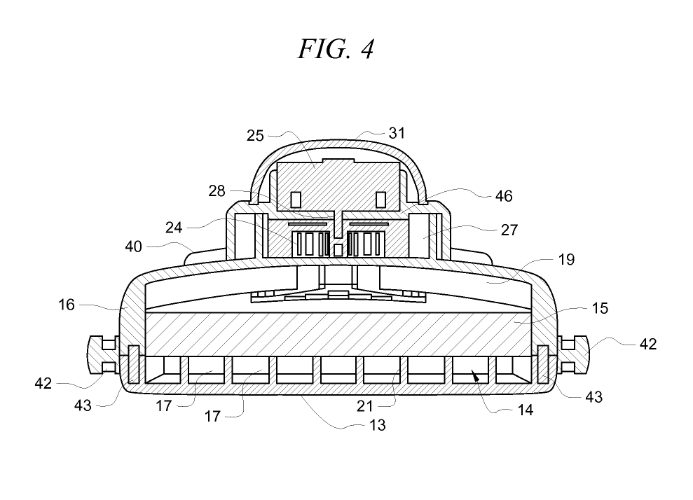

Ambient air inlets 17 are formed in the top wall of rear cover 13 in laterally disposed relation to one another as depicted in FIGS. 2 and 4 to prevent spillage in cases where sponge 15 is over-saturated and the personal humidifier is inadvertently inverted. By comparing FIGS. 2, 4, and 6, it will be understood that each air inlet 17 is in open fluid communication with an elongate air duct 14 and that air ducts 14 are separated from one another by linear struts 21.

The forward-facing peripheral edges of rear cover 13 mate with the rearward-facing peripheral edges of main body 16 and a hollow cavity is formed between the main body and the rear cover when said parts are connected to one another. As best depicted in FIGS. 2 and 4, the cavity houses sponge 15. The free edges of linear struts 21 abuttingly engage sponge 15 at equidistantly spaced intervals along its width as depicted to secure said sponge into its operable position.

Sponge 15 is preferably formed of a cellulous sponge material but it may be formed of any material that is water or liquid retaining or absorbent in nature, air permeable, and that retains water without undue expulsion once saturated. Such materials include, but are not limited to, HDPE, PVA compound sponges, fabric material, and the like.

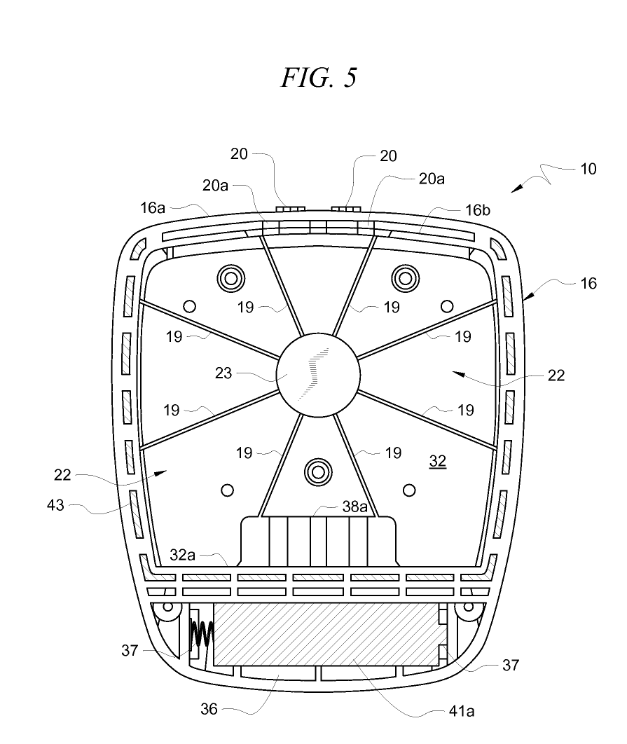

Sponge 15 is preferably soaked with water prior to use, and excessive water is squeezed therefrom until no dripping water is observed. Preferably, sponge 15 is placed into sponge chamber 32 (FIG. 5) with the plane of the sponge being at a right angle to the direction of air flow over the sponge to optimize evaporation efficiency and decrease load on motorized fan assembly 28 (FIG. 3). The shape and size of sponge 15 fits cavity 32 of main body 16 substantially perfectly so that there is no substantial gap between the edges of the sponge and the sidewalls of main body 16 as indicated in FIG. 4.

Rear cover 13 has a generally flat shape and a thickness sufficient to allow substantially even airflow in ducts 14 between linear struts 21 so that air flows over the entire flat surface of sponge 15.

In another embodiment, a set of grills or guards are used in lieu of rear cover 13 to provide an alternative means of providing air inlets and holding sponge 15 in its operative position. Such set of grills or guards, not depicted, are substantially flat in shape and allow a high surface area of sponge 15 to be in immediate communication with ambient air. The grills or guards provide a means of improved air flow due to their reduction of resistance in airflow, but require personal humidifier 10 to be worn with the rear of the unit facing perpendicularly outwards away from the chest.

A groove is formed in the rearwardly-facing sidewalls of main body 16 and a rubber gasket 43 is positioned in each of said grooves as best understood in connection with FIGS. 4 and 5. A similar rubber gasket 43 is positioned along the bottom of sponge chamber 32, in interconnecting relation to the respective lower ends of said gaskets positioned in said sidewalls, as best understood in connection with FIG. 5. A tight seal is formed when the top of removable rear cover 13 is engaged by locking tabs 20 at the top of main body 16.

More particularly, locking tabs 20 are slideably mounted so that they can be displaced away from one another or toward one another. As best depicted in FIG. 5, each locking tab is slideably mounted between an outer top wall 16a of main body 16 and in inner top wall 16b of said main body. A latch 20a extends laterally from each tab 20 and is engaged by an associated catch 20b formed in a forwardly-facing edge of rear cover 13 as best understood in connection with FIG. 2. When locking tabs 20 are positioned close to one another, i.e., when they have been slid towards one another until they can get no closer, catches 20b, 20b of rear cover 13 will not engage said latches when said rear cover is closed. However, with rear cover 13 in its closed position, the user of personal humidifier 10 slides locking tabs away from one another as far as they will go. This brings latches 20a, 20a into engagement with catches 20b, 20b, respectively, thereby preventing removal of rear cover 13. When sponge 15 requires further moisture, locking tabs 20 are slid toward one another to release catches 20b, 20b from latches 20a, 20a and rear cover 13 is removed by pivoting its top wall rearwardly so that ledge 18 may disengage from ridge 18a. The user thus easily gains access into sponge chamber 32 of main body 16 to remove or replace sponge 15.

Propeller 24 (FIGS. 2 and 3) is mounted on an output shaft of DC motor 25 (FIGS. 2 and 4) and rotates conjointly therewith. Said propeller and motor collectively form motorized fan assembly 28 (FIGS. 3 and 4) which blows air from linear air ducts 14 through sponge 15. The fan assembly is preferably adapted to operate at more than one speed.

As best depicted in FIG. 5, a plurality of radial struts, collectively denoted 19, are formed on the rearwardly-facing side of the front wall of main body 16. Intake ducts 22 are formed by contiguous pairs of said struts and guide air, cooled and humidified by passing through moist sponge 15, towards propeller intake opening 23 which is formed substantially in the center of the front wall of main body 16. Air from propeller intake opening 23 is immediately fed to the center of propeller 24. A radial propeller may be used in lieu of such centrifugal propeller. Propeller 24 can also be defined as an impeller because there is a housing around it.

FIG. 3 depicts spiral-shaped duct 26 which operates similar to a blower system. It accumulates expelled air from propeller 24 and constrains the air to follow a path of travel to air outlet duct 27.

Guide vanes 44 are pivotally mounted in air outlet duct 27 to constrain the humidified and cooled outlet airflow to flow vertically upwardly, in the direction of the users' face as depicted in FIG. 1.

Adjustable vents 30, also depicted in FIG. 3, are downstream from guide vanes 44 and enable the user to direct the airflow away from the face if desired.

DC motor 25 is mounted on anti-vibration pad 46 (FIG. 4) and is positioned under ornamental cover 31 in this preferred embodiment.

Ornamental plate or shield 40 (FIGS. 2, 3, and 6) overlies the front wall of main body 16 to conceal wiring of slideably mounted ON/OFF switch 38 which is in electrical communication with motor 25. The part of switch 38 that is behind the front wall of main body 16 is housed within housing 38a, depicted in FIG. 5.

Battery compartment 36 (FIG. 5) is secured to main body 16 at the lower end thereof. Partition wall 32a separates sponge cavity 32 from battery compartment 36. Battery frame 41 (FIG. 2) is fixedly secured to main body 16 below partition wall 32a and provides a frame for removable battery cover 45 (FIG. 2) which has a conventional structure to facilitate access to battery 41a. Battery compartment 36 and battery 41a can be detached from main body 16 resulting in a weight reduction of main body 16 bearing on the wearer's body.

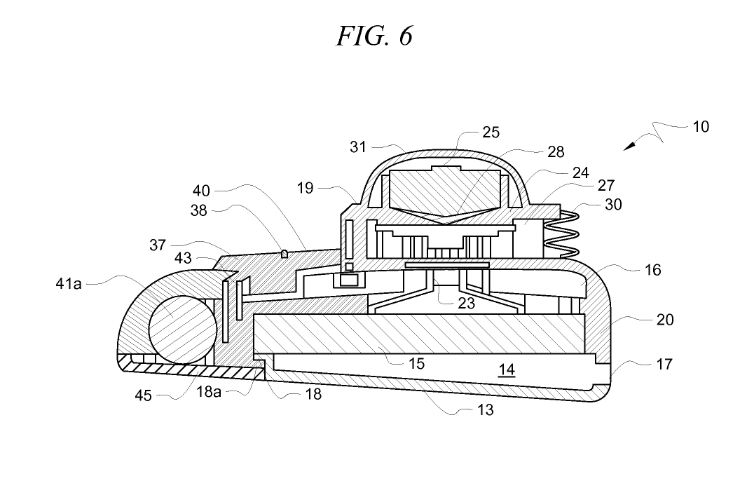

An upper edge of battery frame 41 extends slightly above the plane of partition wall 32a, thereby forming ridge 18a, disclosed above. As depicted in FIGS. 2 and 6, laterally-extending ledge 18 depends from a bottom edge of rear cover 13. To attach rear cover 13 to main body 16, ledge 18 is positioned forwardly of ridge 18a and rear cover 13 is pivoted about ledge 18 into engaging relation with main body 16 so that the lower edge of rear cover 13 is held into its operable position by ridge 18a.

Battery 41a is housed within compartment 36 and supplies power to motor 25. It is electrically connected to ON/OFF switch 38 through contacts 37, 37 and associated conductors. Switch 38 is positioned on the forward side of main body 16 as best depicted in FIG. 6. Battery 41a is a 1.5 Volt DC AA size alkaline battery in this preferred embodiment. Other types of self-contained power sources such as rechargeable solar cells, NiCad, Lithium, or lead acid batteries are within the scope of this invention. ON/OFF switch 38 may be replaced with a toggle push button. LEDs indicating the power status of said switch or selected speed may also be provided. A speed-regulator apparatus or a speed variable adjuster (analog or digital) could be employed. Motor speed control might also be adjusted by an MCU, or by means of a conventional variable resistor or series of switched resistors.

Battery 41a is eliminated in another embodiment of the invention. An external power cord, not depicted, is attached to the unit to provide power to the DC motor. The external power cord includes an adapter for voltage conversion when plugged into a wall power socket, an AC to DC rectifier, a step-down transformer, and is removable from the housing. This feature allows removal of the battery compartment as well, thereby reducing the weight of the device.

A pull-out ribbon that underlies battery 41a is exposed when removable battery cover 45 (FIGS. 1 and 6) is opened. It facilitates removal of said battery in a well-known way.

Aromatherapy fragrance or essential oils may be used in conjunction with the device. Such oils can be applied to sponge 15 so that its scent and essence is carried by the air passing through the sponge. Alternatively, the invention can be used as a personal air purifier without fragrances. This is achieved by saturating the sponge with anti-bacterial and anti-viral solutions. Such solutions purify the air that passes through the sponge.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

What is claimed is:

1. A device adapted to be worn or carried by a user for providing humidified, cooled air for breathing and for moistening dry skin and eyes, comprising:
a hollow housing adapted to be positioned comfortably on the user's body in proximity to the user's facial area so that cooled, humidified air is delivered to said facial area;
said hollow housing having an air inlet for admitting ambient air into said hollow housing;
said hollow housing having an air outlet for delivering airflow towards the facial area of the user;
an air-permeable water-retaining element disposed within said hollow housing; and
air moving means for moving ambient air into said air inlet, through said air-permeable water-retaining element, and through said air outlet directing humidified, cooled air to said facial area.

2. The device of claim 1, further comprising:
an elongate neck strap having opposite ends attached to said hollow housing so that said user may suspend the device from the neck.

3. The device of claim 2, further comprising:
said elongate neck strap having an adjustable length so that the user may position the device at a preselected distance from the facial area.

4. The device of claim 1, further comprising:
said air-moving means including an electric fan assembly disposed within said hollow housing.

5. The device of claim 4, further comprising:
said electric fan assembly including a small DC motor having an output shaft and an impeller mounted to said shaft for conjoint rotation therewith.

6. The device of claim 5, further comprising:
spacing means for creating sufficient space between said air-permeable water-retaining element and an intake of the fan assembly to increase operating efficiency of the device by maximizing the surface of the air-permeable water-retaining element over which air flows.

7. The device of claim 6, further comprising:
said spacing means including a plurality of members adapted to direct air towards the intake of said fan assembly.

8. The device of claim 5, further comprising:
a battery disposed within said housing for delivering power to said small DC motor.

9. The device of claim 8, further comprising:
said housing including a detachable battery compartment adapted to house said battery;
whereby said battery compartment and said battery may be removed from said device to reduce the weight of said device when an alternative power source is available.

10. The device of claim 8, further comprising:
said housing including a detachable battery compartment adapted to house said battery;
an electrical conductor disposed between said battery compartment and said main unit;
whereby said user may remove the battery compartment from the main unit to reduce the weight of the device that is supported by the neck of the user;
whereby the user may position the battery compartment in a pocket, clip said battery compartment to a belt, or the like, to re-distribute the weight of the device;
whereby said electrical conductor enables continued battery operation of the DC motor when the battery compartment is removed from the main unit.

11. The device of claim 5, further comprising:
said small DC motor adapted to operate on power from an electrical power wall socket so that no battery is required to operate the device.

12. The device of claim 1, further comprising:
an opening formed in said hollow housing for providing access by a user to said air-permeable water-retaining element so that liquid fluid may be added to said air-permeable water-retaining element.

13. The device of claim 12, further comprising:
said opening provided in the form of a rear-mounted removable cover that exposes a hollow interior of said hollow housing when removed.

14. The device of claim 1, further comprising:
said air-permeable water-retaining element adapted to hold liquid fluid other than water and said air-permeable water-retaining element formed of a material capable of being saturated.

15. The device of claim 1, further comprising:
said air-permeable water-retaining element adapted to hold aromatherapy oil to provide an aromatic scent to the cooled, humidified air delivered to the user's facial area.

16. The device of claim 1, further comprising:
said air-permeable water-retaining element adapted to hold anti-bacterial or anti-viral liquid fluids to provide purified air delivered to the user's facial area.

17. The device of claim 1, further comprising:
airflow-controlling means for varying output air direction.

18. The device of claim 17, further comprising:
said airflow-controlling means including an adjustable guide vent.

19. The device of claim 1, further comprising:
said air permeable water retaining element being formed of a material selected from a group of materials consisting of cellulous sponge or foam-like porous liquid absorbing material.

20. The device of claim 1, further comprising:
said hollow housing including a plurality of struts, ridges or fins to provide a high engagement area of the air-permeable water-retaining element to the intake air within said hollow housing.

21. A personal humidifier, comprising:
a main body;
said main body including a front wall;
an opening formed in said front wall, substantially centrally thereof;
a top wall, a bottom wall, and a pair of sidewalls extending rearwardly from peripheral edges of said front wall;
a rear cover having peripheral edges that releasably engage respective trailing edges of said top wall, bottom wall, and pair of sidewalls;
a cavity formed when said rear cover is engaged to said main body;
said cavity adapted to accommodate a sponge means therewithin;
said rear cover having a top wall, an imperforate back wall, a pair of sidewalls, and a bottom wall;
a plurality of air inlets formed in said top wall of said rear cover;
a plurality of linear struts formed integrally with said rear cover back wall on a forwardly-facing side thereof;
a plurality of elongate air ducts, there being an elongate air duct defined between each contiguous pair of said linear struts;
a DC motor;
a fan mounted on an output shaft of said DC motor for conjoint rotation therewith;
said DC motor and said fan mounted on a forward side of said main body front wall, substantially centrally thereof, so that motor-driven rotation of said fan constrains ambient air to follow a path of travel through said air inlets, said elongate air ducts, said sponge means, and said opening formed in said front wall;
an air outlet positioned forwardly of said front wall that constrains cooled and humidified air to flow through said air outlet;
whereby said air flow of cooled and humidified air may be breathed by a user.

22. The personal humidifier of claim 21, further comprising:
a partition wall that divides said cavity into an upper sponge compartment and a lower battery compartment; and
said lower battery compartment adapted to accommodate a battery therewithin.

23. The personal humidifier of claim 22, further comprising:
a battery frame fixedly secured to said main body;
a removable battery compartment wall for covering said battery compartment;
a ridge formed by a top edge of said battery frame extending slightly above said partition wall;
said rear cover having a ledge formed along a bottom edge thereof;
said ledge positioned forwardly of and engaging said top edge when said rear cover is secured to said main body.

24. The personal humidifier of claim 23, further comprising:
a pair of catches formed on a forward-facing edge of said rear cover top wall;
said main body having an outer top wall and an inner top wall;
a pair of locking tabs slideably mounted between said main body outer top wall and said main body inner top wall;
a latch extending laterally from each locking tab;
each latch adapted to be engaged by an associated catch formed in said forwardly-facing edge of said rear cover top wall;
whereby when said locking tabs are positioned close to one another, said catches of said rear cover do not engage said latches when said rear cover is disposed in abutting relation to said main body so that said rear cover may be removed from said main body;
whereby when said locking tabs are positioned away from one another, said catches of said rear cover engage said latches and secure said rear cover to said main body.
